(19) United States
(12) Patent Application Publication
(10) Pub. No.: US 2010/0148117 A1
(43) Pub. Date: Jun. 17, 2010

(54) METHOD OF MAKING GLYCEROL MONOESTERS

(76) Inventor: Roger L. Logan, Newfoundland, NJ (US)

Correspondence Address: Intellectual Property Department;DEWITT ROSS & STEVENS S.C., 2 East Mifflin Street, Suite 600, Madison, WI, 53703-2865, US

(21) Appl. No.: 12/332,824

(22) Filed: Dec. 11, 2008

(51) Int. Cl. C09K 3/00

(52) U.S. Cl. 252/182.12

(57) ABSTRACT

Described is a method of producing compositions comprising a high concentration of glycerol monoesters. The method entails reacting a mixture of glycerol, a fatty acid source, and water, in the absence of catalysts, at a temperature preferably from about 180° C. to about 300° C., a pressure preferably from about 15 psig to 400 psig, and for a time sufficient to yield an acid value of preferably from about 2.0 to about 7.0 in the mixture, and a hydroxyl value preferably of from about 260 to about 460 in the mixture. The method can be used to make lipid mixtures comprising 90 wt % or more of glycerol monoesters. The method does not require molecular distillation.

### FIELD OF THE INVENTION

The present invention relates to a process for producing a composition comprising glycerol esters having high monoglyceride content. The process uses water at high temperatures and pressures to drive esterification and trans-esterification reactions involving glycerol and a variety of fatty acids. The process does not require molecular distillation and yields a composition having a monoglyceride content as high as 90% or more.

### BACKGROUND OF INVENTION

It is often necessary to adjust the hydrophilic/lipophilic balance of a lipid-containing composition in favor of higher hydrophilicity. This is conventionally accomplished by increasing the monoglyceride content of the lipid within the composition. Among many other uses, glycerol monoesters and compositions containing glycerol monoesters are typically used to emulsify lard and many other edible products. Several methods for producing lipids with increased monoglyceride content are known. One method is saponification: adding an alkali such as sodium hydroxide to form soaps. Another known method is to add ethoxylates of fatty acids and fatty alcohols. However, the amount of these additives that can be used in edible products is strictly limited.

The conventional method to produce lipid compositions with increased monoglyceride content (without using chemical additives or reactions) is to molecularly distill the monoglycerides from the diglycerides and triglycerides contained in a mixed lipid feed stock. Molecular distillation (also known as short-path distillation) is capable of generating monoglyceride-containing compositions with a monoester content as high as 90-95%. The process, however, is slow, expensive, and requires highly specialized equipment. The commercial products produced by molecular distillation, such as “MYVEROL”-brand distilled monoglycerides (Kerry Group Services, Ltd., Kerry, Ireland) are used extensively in the commercial food industries. For example, monoglyceride compositions are used to improve qualities such as starch complexing in baked goods, pastas and cereals; emulsification and stability in margarine and spreads, especially in low fat products; aeration in whipped toppings; lubrication in extruded foods; anti-staling in bakery products, defoaming in puddings and jams, and oil stabilization in peanut butter.

The molecular distillation process is very complex. In essence, molecular distillation is a type of vacuum distillation that utilizes a vacuum typically less than about 0.01 torr, and often significantly lower. At these very low pressures, the mean free path of molecules is comparable to the size of the equipment and the gaseous phase no longer exerts significant pressure on the substance to be evaporated. Consequently, the rate of evaporation no longer depends on pressure. Mass transport of the distillate is therefore governed by molecular dynamics rather than fluid dynamics. Thus, a short path between the hot surface and the cold condensation surface is required; hence the term “short-path” distillation is synonymous with “molecular distillation.”

The process is performed in either a Hickman spinning base distillation unit or, more recently, a short-path falling film (or rising film) distillation unit. In order not to damage or degrade the final product, the distillation temperature is held to a minimum, and a vacuum is required to decrease the internal pressure of the distillation unit to a very low level, typically less than 5 mtorr (0.67 Pa, 6.7 dynes/cm²). Because there is only one theoretical plate in molecular distillation units, molecular distillation is capable of distilling only about 50% of the monoglycerides in any given solution, per pass. In other words, the separation of monoglycerides from a composition comprising mono-, di-, and triglycerides, in a single cycle, is woefully incomplete. Thus, obtaining a high yield of monoesters by molecular distillation requires multiple distillation cycles.

However, the once-distilled feed stock cannot simply be passed back through the still. The once-distilled feed stock must first be directed to a trans-esterification unit where the content of monoesters in the feed stock is replenished. Excess glycerol and catalysts are added to the once-distilled feed stock (which now contains a high proportion of non-volatile diglycerides and triglycerides) and an enriched monoester mixture is re-generated through trans-esterification of the fatty acid side-chains in the di- and triglycerides and the added glycerol. In effect, fatty acid side-chains are transferred from the diglycerides and triglycerides to the glycerol. The catalyst must then be neutralized. Then (and only then) is the monoester-enriched feed stock ready to be re-introduced into the molecular distillation unit for another round of distillation. The entire process must be repeated after each round of distillation. Multiple iterations of the distillation-trans-esterification cycle are required to obtain a high-yield of monoesters by molecular distillation. As a result, the molecular distillation process is both complex and expensive.

Therefore, there remains a long-felt and unmet need for a method to produce lipid mixtures with a very high percentage of glycerol monoesters of fatty acids, e.g., monoglycerides, without the expensive equipment, low-yields, and iterative recycling steps associated with molecular distillation.

### SUMMARY OF INVENTION

The present invention solves the foregoing problems. The invention is a method of generating high-content monoglycerol ester solutions with water at high temperatures and pressures in esterification and trans-esterification reactions involving glycerol and a variety of sources of fatty acids. This method is unique in that it has at least three departures from the prior art: (1) it employs water as a solvent at elevated temperatures and pressure; (2) involves esterification reactions without a catalyst; and (3) stabilizes glycerin at high temperatures to prevent the formation of the dangerous compound, acrolein.

Thus, the invention is directed to a method of producing a composition of matter comprising glycerol monoesters. One version of the invention comprises reacting a mixture comprising glycerol, a fatty acid source, and water, in the absence of catalysts, at an elevated temperature and at an elevated pressure wherein the glycerol and the water have increased solubility in the fatty acid source as compared to their respective solubilities at room temperature and atmospheric pressure. The mixture is then reacted for a time sufficient to generate a composition of matter comprising at least about 50 wt % glycerol monoesters.

The method can be implemented either batch-wise or continuously.

It is preferred that the mixture be reacted at a temperature of from about 180° C. to about 300° C., more preferably from about 200° C. to about 260° C. It is also preferred that the mixture be reacted at a pressure of from about 15 psig to about 400 psig, more preferably from about 30 psig to about 75 psig. It is preferred that the mixture be reacted for a time sufficient to yield an acid value of from about 2.0 to about 7.0 in the mixture, and a hydroxyl value of from about 260 to about 460 in the mixture. In the most preferred version of the invention, it is preferred that the mixture be reacted for a time sufficient to yield a composition of matter comprising at least about 90 wt % glycerol monoesters. After the reaction is complete, any excess glycerol may optionally be removed from the mixture.

All of the ranges given herein (e.g., for temperature and pressure) include any smaller ranges encompassed within the broadest range. Thus, for example, the pressure range noted in the previous paragraph, about 15 psig to about 400 psig, explicitly includes smaller encompassed ranges such as 20 to 300 psig, 100 to 200 psig, etc.

The fatty acid source used in the invention can derive from any source, without limitation. The fatty acid source may comprise a fatty acid in free acid form or as a glyceride. Thus, for example, the fatty acid can comprise (by way of example and not limitation) a purified fatty acid selected from the group consisting of decanoic acid, lauric acid, myristic acid, palmitic acid, pentadecanoic acid, stearic acid, arachidic acid, behenic acid, lignoceric acid, margaric acid, myristoleic acid, palmitoleic acid, oleic acid, gadoleic acid, erucic acid, ricinoleic acid, linoleic acid, linolenic acid, licanic acid, margaroleic acid, arachidonic acid clupanadonic acid, eicosapentaenoic acid, docosahexaenoic acid, and the like. The fatty acid source may comprise a natural oil or fat, such as (but not limited to) animal fats, soya bean oil, coconut oil, palm oil, palm kernel oil, rapeseed oil, cottonseed oil, linseed oil, sunflower oil, fish oil, algae oil, and the like.

### DETAILED DESCRIPTION OF THE INVENTION

Unless otherwise stated, the following definitions are used throughout the present application:

“Acid value” refers to the mass of potassium hydroxide in milligrams that is required to neutralize one gram of a chemical substance. The acid value measures the amount of carboxylic acid groups in a chemical solution. With respect to the present application, the acid value provides a measure of the free fatty acid groups present in the solution. See ASTM D 1980. Acid value may also be expressed as the number of mL of 0.1 N alkali required to neutralize the free acids in 10.0 g of the substance. This alternative approach is the method utilized by U.S. Pharmacopoeia: 10 g of the test sample is dissolved 50 mL of a mixture of equal volumes of alcohol and ether which has been neutralized to phenolphthalein by adding 0.1 N sodium hydroxide. One (1) mL of phenolphthalein test solution (1 g phenolphthalein in 100 ml alcohol) is then added to the solution. The solution is then titrated with 0.1 N sodium hydroxide until the solution remains faintly pink after shaking for 30 seconds. Record the volume of 0.1 N alkali required to neutralize the solution.

“Fatty acid” as used herein refers to an acyl chain covalently conjugated to a carboxyl functional group. The fatty acid may be in a “free form,” in which the carboxyl group is not further covalently modified, or a “glyceride form,” in which the carboxyl group is further covalently bound to either the alpha or beta position of glycerol via an ester bond. The glyceride form of a fatty acid may contain from one to three fatty acids on any of three possible positions on the glycerol moiety, and the type of fatty acid may be the same or different.

“Hydroxyl value” refers to a measure of hydroxyl (univalent —OH) groups in an organic solution. With respect to the present work, the hydroxyl value provides a measure of the free glycerol present in the solution. See ASTM D1957-86(2001) and JIS K-0070. Hydroxyl value may also be determined according to the USP method:

The hydroxyl value is the number of mg of potassium hydroxide equivalent to the hydroxyl content of 1.0 g of the substance. Pyridine-Acetic Anhydride Reagent: Just before use, mix 3 volumes of freshly opened or freshly distilled pyridine with 1 volume of freshly opened or freshly distilled acetic anhydride.

Procedure—Transfer a known quantity of the substance to a glass-stoppered, 25.0-mL conical flask, and add 5.0 mL of pyridine-acetic anhydride reagent. Transfer 5.0 mL of pyridine-acetic anhydride reagent to a second, glass-stoppered, 250-mL conical flask to provide the reagent blank. Fit both flasks with suitable glass-jointed reflux condensers, heat on a steam bath for 1 hour, add 10 mL of water through each condenser, and heat on the steam bath for 10 minutes more. Cool, and to each add 25 mL of butyl alcohol, previously neutralized to phenolphthalein test solution with 0.5 N alcoholic potassium hydroxide, by pouring 15 mL through each condenser and, after removing the condensers, washing the sides of both flasks with the remaining 10-mL portions. To each flask add 1 mL of phenolphthalein test solution and titrate with 0.5 N alcoholic potassium hydroxide, recording the volume, in mL, consumed by the residual acid in the test solution as “T” and that consumed by the blank as “B.” In a 125-mL conical flask, mix about 10 g of the substance, accurately weighed, with 10 mL of freshly distilled pyridine, previously neutralized to phenolphthalein test solution, add 1 mL of phenolphthalein test solution, and titrate with 0.5 N alcoholic potassium hydroxide, recording the volume, in mL, consumed by the free acid in the test specimen as “A”, or use the acid value to obtain A. Calculate the hydroxyl value by the formula:

(56.11N/W)[B+(WA/C)T]

in which W and C are the weights, in g, of the substances taken for the acetylation and for the free acid determination, respectively; N is the exact normality of the alcoholic potassium hydroxide; and 56.11 is the molecular weight of potassium hydroxide.

“Psig” is an abbreviation for “pounds-force per square inch gauge,” a unit of pressure relative to the surrounding atmosphere.

“Glycerin” and “glycerol” are used interchangeably.

The terms “glycerol ester” and “glyceride” are used interchangeably and refer to a molecule with a glycerol backbone with at least one fatty acid moiety conjugated thereto via an ester bond. Monoglycerides or monoglycerol esters contain one fatty acid moiety; diglycerides contain two fatty acid moieties, and triglycerides contain three fatty acid moieties.

As used herein, percentages mean percent by mass.

The determination of monoglyceride and diglyceride content by capillary gas chromatography was performed as described in the Official Methods and Recommended Practices of the AOCS, Cd 11b-91.

Unless otherwise defined, all other technical and scientific terms used herein have the same meaning as commonly understood by one of ordinary skill in the chemical art.

The invention is a process that yields lipid compositions comprising at least about 80% monoglyceride content, more preferably at least about 85% monoglyceride content, and most preferably at least about 90% total monoglyceride content via a direct esterification reaction with fatty acids and glycerol or via a trans-esterification reaction with glycerides (e.g., diglycerides and triglycerides) and glycerol, in the absence of molecular distillation. The process uses water at high temperature and relatively modest pressure as a co-solvent for both glycerol and the fatty phase and as a stabilizer of the glycerol. The water enhances the solubility of glycerol in the fatty oil phase and allows the glycerol to undergo direct esterification or trans-esterification.

To achieve the desired high monoester content of the product, the solubility of the water and glycerol in the lipid phase must be increased. However, at ambient temperatures, glycerol is nearly insoluble in fatty acids and/or triglycerides such as palm oil and soya oil. A conventional method to increase the solubility of glycerol in the fatty phase is to increase the temperature to as high as 240 to 250° C. However, above 250° C., the glycerol can decompose to acrolein (syn., acrylaldehyde), a very dangerous condition that must be avoided. (Acrolein is a powerful pulmonary irritant and lacrimating agent. It was used as a chemical weapon in World War I.) Most laboratory esterification equipment and commercial plants are designed to operate at atmospheric pressure. This limited design has prevented previous workers from considering the benefits of using water under pressure to increase the solubility of glycerol in the fatty phase while preventing the decomposition of glycerol to acrolein. The present inventors have found that at elevated temperatures, preferably from about 180° C. to about 300° C., and more preferably from about 200° C. to about 260° C., and relatively modest pressure, preferably from about 15 psig to 200 psig, more preferably 30 psig to about 100 psig, water will: (a) act as a co-solvent for glycerol and fatty acid, (b) stabilize the glycerol to prevent the formation of acrolein, (c) promote direct esterification of fatty acids with glycerol without the use of catalysts; and (d) promote trans-esterification of glycerol with long chain glycerides without the use of catalysts. The result is that the process yields compositions having very high monoester content, often as high as 90 to 95%.

Acid and alkaline catalysts have been used in direct esterification reactions with glycerol and fatty acids and trans-esterification reactions with glycerides. However, the catalytic approach typically yields lipid compositions having a monoglyceride content of about 60%, with diglycerides and triglycerides comprising the remaining 40%. The catalysts must be carefully neutralized to prevent reverse reactions during subsequent rounds of distillation. The neutralization process requires removing the salts formed by the neutralization reaction, as well as removing excess glycerol. An unwanted result is that the neutralization and salt/glycerol removal steps cause a loss of monoglyceride content. Thus, the primary advantages of the invention are that no catalyst is necessary in either the esterification or trans-esterification reactions and molecular distillation of the product is not required. In short, the present invention yields a composition with a very high monoester-content, using a direct, single-step reaction, without the use of acid or base catalysts, and without using molecular distillation.

The reactor required to implement the present invention must be capable of withstanding the pressures required—generally up to at least 300 psig (although the reaction can be performed at much lower pressures). To maintain an adequate margin of safety, the reactor should be capable of withstanding sustained internal pressures of at least about 100 to 150 psig. In a preferred design, a valve is installed in a vapor pipe between the reactor and a condenser. The valve in the vapor pipe is bypassed with a control valve bypass line of sufficient size to modulate the pressure within the reactor. In a large reactor, the vapor pipe between the reactor and the condenser may have a diameter of from about 20 to about 30 inches (about 51 to about 76 cm), and the control valve bypass line may have a diameter of from about 3 to 4 inches (about 8 to about 10 cm). Conventional esterification reactors do not have the ability to close off the vapor path and use a controlling bypass to the vapor condenser. Suitable reactors are made by a large number of international commercial suppliers, such as Büchi AG (Uster, Germany).

The fatty acid lipid feed stock to be used in the invention can be derived from any source now known or developed in the future, without limitation, and includes (also without limitation) purified fatty acids, natural oils, and tallow. The purified fatty acids can either be in a free form (i.e., free fatty acids) or conjugated to glycerol in a glyceride form (i.e. mono-, di-, and/or triglycerides). The fatty acids can be substituted or unsubstituted, saturated or unsaturated, and have fatty acid chain lengths of from 2 to 30, and preferably from 10 to 30 carbon atoms, and most preferably from 10 to 22 carbon atoms. Examples of preferred fatty acids include (without limitation) decanoic acid, lauric acid, myristic acid, palmitic acid, pentadecanoic acid, stearic acid, arachidic acid, behenic acid, lignoceric acid, margaric acid, myristoleic acid, palmitoleic acid, oleic acid, gadoleic acid, erucic acid, ricinoleic acid, linoleic acid, linolenic acid, licanic acid, margaroleic acid, arachidonic acid clupanadonic acid, eicosapentaenoic acid, docosahexaenoic acid, soya bean-derived fatty acids, coconut oil-derived fatty acids, palm oil-derived fatty acids, palm kernel-derived fatty acids, and tallow-derived fatty acids. The natural oils can include plant and animal-derived oils, including soya bean oil, coconut oil, palm oil, palm kernel oil, rapeseed oil, linseed oil, sunflower oil, fish oil, and algae oil.

Sufficient water must be present to act as a co-solvent for glycerol and the fatty phase. In using fatty acids as a feed stock, the water of reaction will be 5 to 10% depending on the molecular weight of the fatty acid. The water of reaction should be sufficient to supply enough water to act as a co-solvent and stabilizer for the glycerol if it is not allowed to vent from the reactor.

As the fatty acid chain length is increased, the solubility of water and glycerol in the fatty phase decreases substantially. As the fatty acid chain length approaches 20 carbon atoms and beyond, this limits the amount of monoglycerides that can be formed from about 40% to about 55% of total content (by weight). It is necessary to dissolve water in the fatty phase to the extent of about 5% to about 20% of the fatty phase for efficient esterification to occur. To increase the solubility of water and glycerol in the fatty phase in the case of long-chain fats or other especially hydrophobic fats (thereby to increase the yield of monoglycerides), the reaction temperature may have to be elevated to above about 200° C. Pressures in the range of 20 psig to 400 psig provide sufficient water to accomplish this desired result. In addition, an external source of steam or water may also be supplied.

As the reaction proceeds and more glycerol monoesters form, the fatty phase becomes increasingly more hydrophilic. The increased hydrophilicity of the fatty phase allows for more water to be dissolved in the fatty phase, which increases the solubility of glycerol in the fatty phase. This cascade of increasing hydrophilicity promotes higher monoester content in the final product.

When natural oils comprising a high concentration of triglycerides are used as the feed stock (such as soya oil, tallow, or palm oil), no water is produced from the trans-esterification reaction. Therefore, the reaction should be supplemented with an external source of water or steam and/or an external source of fatty acids.

When the reaction is complete, the reaction is cooled. The insoluble glycerol collects in the bottom layer and is drawn off. The soluble glycerol is separated from the lipid fraction by any suitable method, typically conventional distillation. Alternatively, in large-scale installations, both the insoluble and soluble glycerol can be distilled from the monoesters. In yet another alternative, the excess glycerol can be stripped from the monoesters in a high-vacuum, counter-current stripping column.

### EXAMPLES

The following Examples are included solely to provide a more complete understanding of the present invention. The Examples do not limit the scope of the invention disclosed and claimed herein in any fashion.

### Example 1

### Generation of a 90% Monoester Solution of Glycerol Monolaurate by Direct Esterification Reaction

A reactor was equipped with an agitator, then-no well, pressure control valve, relief valve, cooling coils, sample line, and vapor condenser to enable it to regulate temperature and pressure. Unless designated otherwise, “parts” are parts by weight. The following were charged to the reactor at 80° C.:

1000 pts. 99% glycerol;

1400 pts. lauric acid; and

350 pts. water.

The pressure reactor was rapidly heated from 80° C. to 220-230° C. The reactor developed a pressure of 45 psig which was slowly reduced to 30-35 psig over 2 hours. The reactor was sampled for acid value. The acid value was 5.5. The pressure was reduced to 15 psig while the temperature was held at 230° C. After one hour at 15 psig and 230° C., the pressure was reduced to atmospheric, and the reactor was rapidly cooled to 80° C. The excess glycerol was removed with multiple washes until the free glycerol content was below 0.5%. The product was dried under a vacuum at 80° C.

The final glycerol monolaurate solution had the following properties:

Hydroxyl value: 405 (over 90% monoester).

Acid value: 2.5

Melting point: 54.0° C.

Free glycerol: 0.3%

These results show that a 90% monoester solution of glycerol monolaurate can be generated in a direct esterification reaction using the above methods.

### Example 2

### Generation of a 90% Monoester Solution of Glycerol Monooleate by Direct Esterification Reaction

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerol;

1400 pts. oleic acid; and

450 pts. water.

The pressure reactor was rapidly heated from 80° C. to 250-255° C. The reactor developed a pressure of 200 psig which was slowly reduced to 100-110 psig over 2 hours. The reactor was sampled for acid value. The acid value was 6.1. The pressure was reduced to 10 psig while the temperature was held at 250° C. After one hour at 10 psig and 250° C., the pressure was reduced to atmospheric, and the reactor was rapidly cooled to 170° C. The excess glycerol was removed by distillation in a continuous counter-current stripping tower operating at a pressure of less than 5 torr and a temperature of 170° C. with the assistance of steam.

The final glycerol monooleate solution had the following properties:

Hydroxyl value: 318 (over 90% monoester).

Acid value: 2.0

Free glycerol: 0.4%

These results show that a 90% monoester solution of glycerol monooleate can be generated in a direct esterification reaction using the above methods.

### Example 3

### Generation of a 90% Monoester Solution by Trans-Esterification Reaction with Soya Bean Oil and Glycerol

A reactor was equipped with an agitator, thermo well, pressure control valve, relief valve, cooling coils, sample line, high-pressure steam line through sparge ring, and vapor condenser to enable it to regulate temperature and pressure. The following were charged to the reactor at 80° C.:

1000 pts. 99% glycerol;

1780 pts. soya oil;

120 pts. soya fatty acids; and

450 pts. water.

The pressure reactor was rapidly heated from 80° C. to 250° C. The reactor developed a pressure of 125-150 psig. After six hours, the reactor was sampled for acid value. The acid value was 2.5. The pressure was reduced to 10 psig while the temperature was maintained at 250° C. After 1.5 hours at 10 psig and 250° C., the pressure was reduced to atmospheric, and the reactor was cooled to 170° C. The excess glycerol was removed from the reactor by high vacuum distillation at a pressure of less than 5 torr and with the assistance of dry steam.

The final composition had the following properties:

Hydroxyl value: 315 (over 90% monoester)

Acid value: 1.5

Free glycerol: 0.4%

These results show that a 90% monoester solution can be generated from monosoya fats in a trans-esterification reaction using the above methods.

### Example 4

### Generation of a 90% Monoester Solution of Glycerol Monoerucate by Direct Esterification Reaction

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerol;

1700 pts. erucic acid; and

400 pts. water.

The pressure reactor was rapidly heated from 80° C. to 250-255° C. The reactor developed a pressure of 125-150 psig which was slowly reduced to 70-75 psig over 2 hours. The reactor was sampled for acid value. The acid value was 6.5. The pressure was reduced to 10 psig while the temperature was held at 250° C. After one hour at 10 psig and 250° C., the pressure was reduced to atmospheric, and the reactor was rapidly cooled to 170° C. The excess glycerol was removed from the reactor by high-vacuum distillation at a pressure of less than 5 torr with the assistance of dry steam.

The final glycerol monoerucate solution had the following properties:

Hydroxyl value: 270 (over 90% monoester).

Acid value: 1.5

Free glycerol: 0.4%

These results show that a 90% monoester solution of glycerol monoerucate can be generated in a direct esterification reaction using the above methods.

### Example 5

### Generation of a 90% Monoester Solution of Glycerol Monodecanoate by Direct Esterification Reaction

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerol;

1100 pts. decanoic acid; and

350 pts. water.

The pressure reactor was heated rapidly from 80° C. to 210-220° C. The reactor developed a pressure of 35 psig which was slowly reduced to 25-30 psig over 2 hours. The reactor was sampled for acid value. The acid value was 6.0. The pressure was reduced to 10 psig while the temperature was held at 225° C. After one hour at 10 psig and 225° C., the pressure was reduced to atmospheric, and the reactor was rapidly cooled to 80° C. The excess glycerol was washed out with multiple washes until the free glycerol content was below 0.4%. The product was dried under a vacuum at 80° C.

The final glycerol monodecanoate solution had the following properties:

Hydroxyl value: 454 (over 90% monoester).

Acid value: 2.5

Free glycerol: 0.4%

These results show that a 90% monoester solution of glycerol monodecanoate can be generated in a direct esterification reaction using the above methods.

### Example 6

### Generation of a 90% Monoester Solution by Trans-Esterification Reaction with Coconut Oil and Glycerol

A reactor was equipped with an agitator, then no well, pressure control valve, relief valve, cooling coils, sample line, high-pressure steam line through sparge ring, and vapor condenser to enable it to regulate temperature and pressure. The following were charged to the reactor at 80° C.:

1000 pts. 99% glycerol;

1800 pts. coconut oil;

140 pts. coconut fatty acids; and

400 pts. water.

The pressure reactor was heated rapidly from 80° C. to 240° C. The reactor developed a pressure of 80-85 psig. After four hours, the reactor was sampled for acid value. The acid value was 2.0. The pressure was reduced to 10 psig while the temperature was maintained at 240° C. After 1.0 hours at 10 psig and 240° C., the pressure was reduced to atmospheric, and the reactor was cooled to 170° C. The excess glycerol was removed by distillation in a counter-current stripping tower operating at less than 5 torr pressure and 170° C. with the assistance of steam.

The final coconut-oil monoglyceride product had the following properties:

Hydroxyl value: 366 (over 90% monoester)

Acid value: 1.0

Free glycerol: 0.2%

These results show that a 90% monoester solution derived from coconut oil and glycerol can be generated by a trans-esterification reaction using the above methods.

### Example 7

### Generation of a 90% Monoglyceride Solution by Trans-Esterification Reaction with Tallow and Glycerol

A reactor was equipped with an agitator, thermo well, pressure control valve, relief valve, cooling coils, sample line, high-pressure steam line through sparge ring, and vapor condenser to enable it to regulate temperature and pressure. The following were charged to the reactor at 80° C.:

1000 pts. 99% glycerin;

1800 pts. tallow;

140 pts. tallow fatty acids; and

425 pts. water.

The pressure reactor was heated rapidly from 80° C. to 255° C. The reactor developed a pressure of 200-210 psig. After four hours, the reactor was sampled for acid value. The acid value was 3.5. The pressure was reduced to 10 psig while the temperature was maintained at 250° C. After 1.5 hours at 10 psig and 250° C., the pressure was reduced to atmospheric, and the reactor was cooled to 170° C. The excess glycerol was removed by distillation in a counter-current stripping tower operating at less than 5 tort and 170° C. with the assistance of steam.

The final solution of monoglycerides from tallow had the following properties:

Hydroxyl value: 309 (over 90% monoester)

Acid value: 2.3

Free glycerol 0.3

These results show that a 90% monoester solution of monoglycerides can be generated from tallow in a trans-esterification reaction using the above methods.

### Example 8

### Generation of a 90% Monoglyceride Solution by Trans-Esterification Reaction with Palm Oil and Glycerol

A reactor was equipped with an agitator, thermo well, pressure control valve, relief valve, cooling coils, sample line, high-pressure steam line through sparge ring, and vapor condenser to enable it to regulate temperature and pressure. The following were charged to the reactor at 80° C.:

1000 pts. 99% glycerin;

1750 pts. palm oil;

145 pts. palm oil fatty acids; and

450 pts. water.

The pressure reactor was heated rapidly from 80° C. to 255° C. The reactor developed a pressure of 200 psig. After four hours, the reactor was sampled for acid value. The acid value was 3.0. The pressure was reduced to 10 psig while the temperature was maintained at 250° C. After 1.5 hours at 10 psig and 250° C., the pressure was reduced to atmospheric, and the reactor was cooled to 170° C. The excess glycerol was removed from the reactor by high vacuum distillation with the assistance of steam. The vacuum pressure was below 5.0 torr, and the temperature was 170-175° C.

The final palm oil monoglyceride solution had the following properties:

Hydroxyl value: 307 (over 90% monoester)

Acid value: 2.0

Free glycerol: 0.2%

These results show that a 90% monoester solution of monoglycerides can be generated from palm oil and glycerol in a trans-esterification reaction using the above methods.

### Example 9

### Generation of a 90% Monoglyceride Solution of Glycerol Monostearate by Direct Esterification Reaction

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerol;

1400 pts. stearic acid (70% C18/30% C16); and

500 pts. water.

The pressure reactor was heated rapidly from 80° C. to 255-260° C. The reactor developed a pressure of 150-175 psig, which was slowly reduced to 80 psig over 2 hours. The reactor was sampled for acid value. The acid value was 6.5. The pressure was reduced to 10 psig while the temperature was held at 250° C. After one hour at 10 psig and 250° C., the pressure was reduced to atmospheric, and the reactor was rapidly cooled to 170° C.

The excess glycerol was removed from the reactor by high vacuum distillation at less than 5 torr and applying dry steam.

The final glycerol monostearate solution had the following properties:

Hydroxyl value: 320 (over 90% monoester)

Acid value: 1.5

Free glycerol: 0.5%

These results show that a 90% monoester solution of glycerol monostearate can be generated by a direct esterification reaction using the above methods.

### Example 10

### Generation of a 90% Monoglyceride Solution by Trans-Esterification Reaction with Rapeseed Oil Containing a High Content of Erucic Acid and Glycerol

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerin;

1850 pts. rapeseed oil;

450 pts. water.

The pressure reactor was heated rapidly from 80° C. to 250-255° C. The reactor developed a pressure of 400 psig, which was slowly reduced to 100-110 psig over four hours. The reactor was sampled for acid value. The acid value was 6.5. The pressure was reduced to 10 psig while the temperature was maintained at 250° C. After one hour at 10 psig and 250° C., the pressure was reduced to atmospheric, and the reactor was rapidly cooled to 170° C. The excess glycerol was removed from the reactor by high vacuum distillation with the assistance of dry steam at a pressure less than 5.0 torr.

The final rapeseed monoglyceride solution had the following properties:

Hydroxyl value: 285 (over 90% monoester)

Acid value: 1.5

Free glycerol: 0.6%

These results show that a 90% monoester solution of monoglycerides can be generated from rapeseed oil and glycerol in a trans-esterification reaction using the above methods.

### Example 11

### Generation of a Very-High Monoester Solution of Glycerol Monoricinoleate by Direct Esterification Reaction

A reactor was equipped with an agitator, thermo well, pressure control valve, relief valve, cooling coils, sample line, and vapor condenser to enable it to regulate temperature and pressure. The following were charged to the reactor at 80° C.:

1000 pts. 99% glycerol;

1550 pts. ricinoleic acid; and

400 pts. water.

The pressure reactor was rapidly heated from 80° C. to 250-255° C. The reactor developed a pressure of 110 psig, which was slowly reduced to 50-55 psig over 3 hours. The reactor was sampled for acid value. The acid value was 6.3. The pressure was reduced to 10 psig while the temperature was held at 150° C. After one hour at 10 psig and 250° C., the pressure was reduced to atmospheric, and the reactor was rapidly cooled to 160° C. The excess glycerol was removed by distillation in a continuous counter-current stripping tower operating at a pressure of less than 2 torr and a temperature of 160° C. with the assistance of steam.

The final glycerol ricinoleate solution had the following properties (note that ricinoleic acid has a hydroxyl group at the 12^{th} carbon):

Estimated monoglycerol content as determined by gas chromatography: 80%

Acid value: 4.1

Free glycerol: 1.2%

These results show that a very-high monoester solution of glycerol monoricinoleate can be generated in a direct esterification reaction using the above methods.

What is claimed is:

1. A method of producing a composition of matter comprising glycerol monoesters, the method comprising: reacting a mixture comprising glycerol, a fatty acid source, and water, and devoid of catalysts, at an elevated temperature and at an elevated pressure wherein the glycerol and the water have increased solubility in the fatty acid source as compared to their respective solubilities at room temperature and atmospheric pressure, for a time sufficient to generate a composition of matter comprising at least about 50 wt % glycerol monoesters.

2. The method of claim 1, comprising reacting the mixture at a temperature of from about 180° C. to about 300° C.

3. The method of claim 1, comprising reacting the mixture at a temperature of from about 200° C. to about 260° C.

4. The method of any one of claims 1, 2, or 3, comprising reacting the mixture at a pressure of from about 15 psig to about 400 psig.

5. The method of claim 4, comprising reacting the mixture for a time sufficient to yield an acid value of from about 2.0 to about 7.0 in the mixture.

6. The method of claim 5, comprising reacting the mixture for a time sufficient to yield a hydroxyl value of from about 260 to about 460 in the mixture.

7. The method of claim 6, comprising reacting the mixture for a time sufficient to yield a composition of matter comprising at least about 90 wt % glycerol mono esters.

8. The method of any one of claims 1, 2, or 3, comprising reacting the mixture at a pressure of from about 30 psig to about 75 psig.

9. The method of claim 8, comprising reacting the mixture for a time sufficient to yield an acid value of from about 2.0 to about 7.0 in the mixture.

10. The method of claim 9, comprising reacting the mixture for a time sufficient to yield a hydroxyl value of from about 260 to about 460 in the mixture.

11. The method of claim 10, comprising reacting the mixture for a time sufficient to yield a composition of matter comprising at least about 90 wt % glycerol monoesters.

12. The method of claim 1, further comprising, after the reacting step, removing excess glycerol from the mixture.

13. The method of claim 1, wherein the fatty acid source comprises a fatty acid in free acid form.

14. The method of claim 1, wherein the fatty acid source comprises a glyceride.

15. The method of claim 1, wherein the fatty acid source comprises a purified fatty acid selected from the group consisting of decanoic acid, lauric acid, myristic acid, palmitic acid, pentadecanoic acid, stearic acid, arachidic acid, behenic acid, lignoceric acid, margaric acid, myristoleic acid, palmitoleic acid, oleic acid, gadoleic acid, erucic acid, ricinoleic acid, linoleic acid, linolenic acid, licanic acid, margaroleic acid, arachidonic acid clupanadonic acid, eicosapentaenoic acid, and docosahexaenoic acid.

16. The method of claim 1, wherein the fatty acid source comprises a natural oil or fat.

17. The method of claim 1, wherein the natural oil or fat is selected from the group consisting of animal fats, soya bean oil, coconut oil, palm oil, palm kernel oil, rapeseed oil, cottonseed oil, linseed oil, sunflower oil, fish oil, and algae oil.

18. A method of producing a composition of matter comprising glycerol monoesters, the method comprising:
reacting a mixture comprising glycerol, a fatty acid source, and water, and devoid of catalysts, at a temperature of from about 180° C. to about 300° C., and a pressure of from about 15 psig to 400 psig, for a time sufficient to yield an acid value of from about 2.0 to about 7.0 in the mixture, and a hydroxyl value of from about 260 to about 460 in the mixture; and then
removing excess glycerol from the mixture, thereby yielding a composition of matter comprising at least about 90 wt % glycerol monoesters.
